(19) United States
(12) Patent Application Publication
(10) Pub. No.: US 2013/0228011 A1
(43) Pub. Date: Sep. 5, 2013

(54) MICROWAVE WINDOW AND FILL LEVEL SENSOR USING THE RADAR PRINCIPLE

(71) Applicant: KROHNE MESSTECHNIK GMBH, Duisburg (DE)

(72) Inventors: Nils POHL, Bochum (DE); Michael DEILMANN, Essen (DE); Michael GERDING, Bochum (DE)

(73) Assignee: KROHNE MESSTECHNIK GMBH, Duisburg (DE)

(21) Appl. No.: 13/659,293

(22) Filed: Oct. 24, 2012

(30) Foreign Application Priority Data
Mar. 1, 2012 (DE) 10 2012 003 948.4

(51) Int. Cl. G01F 23/284; H01P 1/08

(52) U.S. Cl. CPC G01F 23/284; H01P 1/08
USPC 73/290 V; 333/252

(57) ABSTRACT

A microwave window (1) for spatial separation and microwave connection of a first space (2) from or with a second space (3) having an at least partially microwave-transparent pane (8) with two sides (6, 7) opposing one another. To provide a microwave window, which allows for an alternative reduction of the reflection of waves, the pane (8) is provided with at least one indentation or recess (9) on at least one side (6). The window (1) is incorporated into a fill level measuring system (10) using the radar principle.

### BACKGROUND OF THE INVENTION

1. Field of the Invention

The invention relates to a microwave window for spatial separation and microwave connection of a first space from or with a second space having an at least partially microwave-transparent pane with a pair of opposite sides. Furthermore, the invention relates to a fill level sensor using the radar principle having at least one antenna emitting electromagnetic radiation.

2. Description of Related art

In industrial measurement technology, radar fill level sensors are often used for determining the fill level of media, such as liquids, bulk materials or also slurries in containers, such as tanks or silos. The transit time method implemented by the measuring device is based on the physical law that e.g., the path of an electromagnetic signal is equal to the product of transit time and propagation speed. In the case of measurement of the fill level of a medium—for example, a liquid or a bulk material—in a container, the signal path corresponds to twice the distance between an antenna emitting an electromagnetic signal and receiving it again and the surface of the medium. The wanted echo signal—i.e., the signal reflected on the surface of the medium—and its transit time are determined using the so-called echo function or the digitized envelope curve. The envelope curve represents the amplitudes of the echo signals as a function of the distance “antenna—surface of the medium”. The fill level can be calculated from the difference between the known distance of the antenna to the floor of the container and the distance of the surface of the medium to the antenna determined by measurement. These emitted and received electromagnetic signals are usually microwave radiation.

Depending on the type of medium or the prevailing process conditions, negative or very high positive pressure, very low or very high temperatures can prevail in the containers; the media can further be very aggressive and/or corrosive. Normally, it is also necessary that the containers be sealed so that the media are not able to leak into the environment. In order to comply with general and also special—as the case may be for sensitive components of the measuring device (e.g., temperature sensitivity of the electronic components)—relevant safety aspects, the microwave window, described at the beginning, is known in the prior art. Such windows preferably are made of glass or ceramics, e.g., METAGLAS®, quartz glass or boron-silicate glass in the presence of high pressures or of synthetic materials, such as polypropylene, polytetrafluoroethylene and polyetheretherketone (PEEK) for reduced required pressure resistance.

German Patent DE 195 42 525 C2 and corresponding U.S. Pat. No. 5,770,990 describe a microwave window that is located within a hollow waveguide. Such hollow waveguides serve, in general, for transmitting the electromagnetic signals between an electronics unit generating signals or processing received signals and the emitting or receiving antenna. The microwave window causes, on the one hand, a pressure and diffusion resistant separation between the inner chamber and the surroundings and, on the other hand, a transmission of the microwaves between the two spaces.

A measurement arrangement is described in German Patent Application DE 43 36 494 A1 and corresponding U.S. Pat. No. 5,594,449, in which the measuring device is located completely outside of the container and in which a microwave window serving as a passage for the microwaves between the surroundings and the inside of the container is set ins the container wall.

A problem involved with the above-mentioned microwave windows is the reflection of waves occurring on them. In order to reduce such reflections, the thickness of the window, for example, is chosen that is equal to an uneven multiple of the half of the wavelength of the measuring signal emitted for measurement, so that the reflected waves interfere destructively. A damping layer is provided in German Patent Application DE 43 36 494 A1 and corresponding U.S. Pat. No. 5,594,449, which damps the measuring signal and the reflected signals, but damps the reflected signals more intensely since it undergoes more reflections. A further variation involves applying an adaptation layer on the window pane to produce a destructive interference of the reflected waves. In order for this to work, the thickness of the adaptation layer has to be equal to an uneven multiple of one fourth of the wavelength of the measuring signal.

The dielectric constant of the adaptation layer should additionally be equal to the geometric mean of the dielectric constants of the media adjacent to the adaptation layer. In the case of two media adjacent to the adaptation layer, this means that the dielectric constant of the adaptation layer is equal to the square root of the product of the dielectric constants of both adjacent media. A disadvantage of such adaptation or damping layers is the increased effort in producing and applying them on the panes and also the requirement that these layers also have to be suitable for the application conditions.

### SUMMARY OF THE INVENTION

The primary object of the invention is, thus, to provide a microwave window and a fill level sensor provided with this window, which allows for an alternative means for reducing the reflection of waves.

This object is initially and essentially met according to the invention by the microwave window having at least one indentation on at least one side, wherein the section of the pane below the indentation allows microwave radiation to pass through and the side layer damped by the indentation serves as an adaptation layer for reducing reflection. In one design, multiple indentations are provided on the side—with same or a different design. The dielectric constant of the adaptation layer formed by indentations is less than the indentation-free layer of the lens below it and is dependent on the dimensioning of the indentations and on the ratio of surface percentage of indentations to surface percentage not damped by indentations. Simulations can be used, for example, for specifying the form of the indentations. One advantage here is that the adaptation layer, which results from the indentations as a sort of thinning of the pane, is an integral component of the microwave window. The indentations can be applied mechanically or chemically in a solid pane or the pane is manufactured having indentations, e.g., molded.

The adaptation layer resulting from the indentations is practically then homogenous for penetrating electromagnetic radiation when the dimensions of the indentations, i.e., the structures implemented in the surface, are small compared to the wavelength of the electromagnetic radiation that is to be transmitted through the microwave window. When the indentation has a dimension in one direction in the plane of the microwave window that is smaller than the wavelength of the electromagnetic radiation to be transmitted through the microwave window, then the microwave window has the desired filter characteristics at least in this direction; in this manner, polarization effects can be achieved.

One design provides that the surface provided with indentations is different according to amount than the surface without indentations, i.e., is larger or smaller. The layer determined by the depth of the indentations has two different surfaces: on the one hand, the section with indentations, i.e., the space that is free of the material of the pane and, on the other hand, the section found between the indentations. The design provides that the surface area of the indentations is greater than the remaining surface area of the side of the pane being observed. In this design, the space that is free of the material of the pane is greater in the observed layer. The dimensioning results depending on the character of the material of the pane and also on the wavelength of the used microwave signal.

When a surface percentage x of the microwave window or adaptation layer is damped by the indentation or indentations and consequently the surface percentage (1−x) of the microwave window consists of bridged structure, then the effective permittivity ∈_{eff} of the adaptation layer that results is approximately defined by the relationship ∈_{eff}=x·∈ᵥ+(1−x)·∈ₘ, wherein ∈ᵥ is the permittivity of the volume created by the indentations and wherein ∈ₘ is the permittivity of the remaining window material. When the indentations are simply filled with surrounding air, ∈ᵥ is practically equal to 1. Because of the known and above-described correlation for adaptation layers in this case, the permittivity ∈_{eff} of the adaptation layer should be the same as the square root of the product of the permittivities of the material of the bridged structure of the microwave window or, respectively, the microwave window and the permittivity of the indentations. Thus, the relative effective permittivity of the adaptation layer should be the same as the square root of the relative permittivities of the materials of the bridged structure. If for example, the material of the microwave window is boron-silicate glass having a relative permittivity of ∈ₘ=5,4, then at ∈ᵥ=1, a required surface percentage x of the indentations of almost exactly x=70% results. The thickness of the adaptation layer has to be one fourth of the wavelength of the electromagnetic radiation to be transmitted and guided through the material of the pane.

One design provides that at least one part of the indentations is designed in the form of slits. At least one part of the slit-shaped indentations is arranged parallel to one another on the side having the indentations. The length, width and depth of the slits can be adapted to the conditions and requirements of the application, e.g., the material of the pane, the used wavelength of the signal, the measure of the reduction of reflection, the bandwidth of the measuring signal, etc. In one design, the slits extend perpendicular to the surface of the side in the direction of the pane. A behavior of the pane dependent on direction results due to the parallel arrangement of the slit-shaped indentations.

In the two following designs, at least one part of the indentations is designed essentially cylindrical. The cylinders extend in particular perpendicular to the plane of the side in the direction of the pane with their longitudinal axes. In one design, at least a part of cylindrical indentations is arranged as points on an essentially Cartesian coordinate system on the side, and in the other design, at least a part of the cylindrical indentations is arranged as points on an essentially hexagonal coordinate system on the side. The cylindrical indentations, which can have a circular, angular or other arbitrary base area, are dispersed on the side of the pane in both designs. Thereby, both designs differ in the type of arrangement. Due to the essentially uniform dispersion in both designs, there is essentially no dependence on the direction of the reflection behavior of the pane. The diameter of the holes and their distances relative to one another on the side can be optimized e.g., using simulations. In one design, the indentations are arranged as points on a Cartesian or orthogonal coordinate system and, in the other design, the indentations are arranged as points on a hexagonal coordinate system. In an alternative design, the cylindrical indentations are dispersed chaotically on the side in order to achieve an isotropic as possible transmitting behavior.

In another design, each side of the pane are provided with at least one indentation. In another design, both sides also have a plurality of indentations. This design corresponds to the case in which the pane is provided with an adaptation layer on both sides.

In another design, an additional covering layer is provided on at least one side of the pane. In a variation, the covering layer is at least partially arranged in the at least one indentation and in another variation, the at least one indentation or the indentations are left out.

Furthermore, the above described object is met in a further teaching of the invention with a fill level sensor using the radar principle as mentioned at the beginning in that the fill level sensor has at least one microwave window according to one of the above-mentioned designs. The microwave window is a component of a hollow waveguide in one design and is built into the container in another design, where the medium is found in the container and further components of the actual measuring device such as antenna, waveguide or electronic components are found outside of the container.

A design of the fill level sensor comprises the depth of the at least one indentation being essentially equal to one fourth of the wavelength of the electromagnetic radiation emitted from the antenna. If the depth of the indentation corresponds to one fourth of the wavelength of the electromagnetic signal emitted as measuring signal, the thickness of the sections of the pane adjacent to the indentations is thus also one fourth of the wavelength, which is why destructive interference is the result with the reflected waves and, for reasons of energy conservation, a higher transmission factor is achieved. In another design, in particular the thickness of the indentation-free layer, which is directly adjacent to the layer with indentations, is equal to a multiple of the half of the wavelength of the measuring signal.

In detail there is a plurality of possibilities for designing and further developing the microwave window according to the invention and the fill level sensor according to the invention as will be apparent from the following description of preferred embodiments in conjunction with the accompanying drawings.

### BRIEF DESCRIPTION OF THE DRAWINGS

FIG. 1 is a schematic representation, not to scale, of a fill level measurement device using a fill level sensor according to the invention,

FIGS. 2a-2c are schematic cross-sectional views, not to scale, showing the structure of a pane of a microwave window according to the invention three different patterns of recesses,

FIG. 3 a top view of a pane, not to scale, of a first embodiment of a microwave window according to the invention,

FIG. 4 is a top view of a pane, not to scale of a second embodiment of a microwave window according to the invention, and

FIG. 5 a top view of a pane, not to scale, of a third embodiment of a microwave window according to the invention.

### DETAILED DESCRIPTION OF THE INVENTION

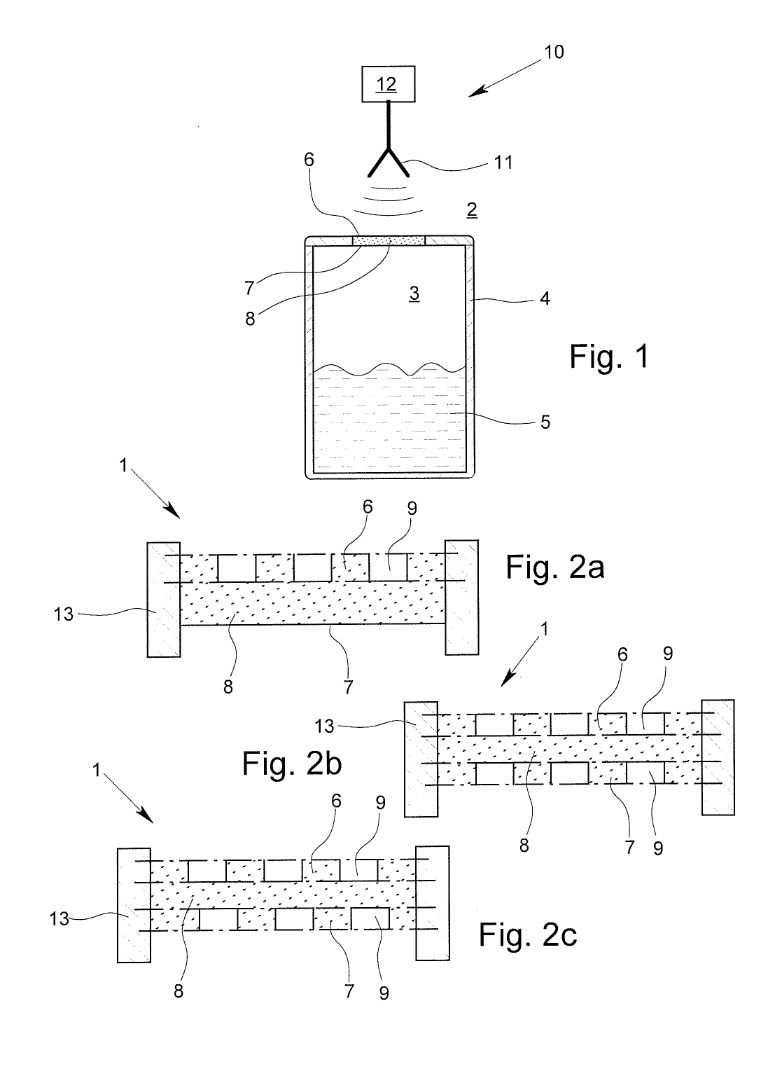

FIG. 1 shows how a microwave window 1 according to the invention is arranged between a first space 2 and a second space 3, the second space 3 being the inner space enclosed by the container 4 and in which the medium 5 is found and the first space 2 being the environment around the container 4. The microwave window 1 has two sides 6, 7, wherein a first side 6 faces the first space 2, i.e., the environment and the other side faces the inside of the container 4, i.e., the second space 3. The passage for the microwaves used for the measurement of the fill level of the medium 5, i.e., the measuring signal, is created by the pane 8, which is made, for example, of glass, ceramics or synthetic material and is transparent for microwaves. The microwave window 1 is a part of the measuring system 10 having the actual measuring device arranged completely outside of the container 4, which is shown here with an antenna 11 and an electronic component 12.

The measuring system 10 is thus comprised, overall, of a separate measuring device and the window 1 that is set in the container 4. The electromagnetic radiation (here, microwaves) emitted from the antenna 11 as a measuring signal reach the second space 3 in the container 4 through the microwave window 1. The microwave signal reflected on the surface of the medium 5 then goes back through the microwave window 1 into the first space 2 surrounding the container 4, in order to be received by the antenna 11 and evaluated by the electronic components 12 or to be further processed. If the microwave window 1 is, in particular, designed in a pressure-proof or diffusion-proof manner, then the first space 2 and the second space 3 are separated from one another, but are joined to one another in view of the microwave signal.

The sectional view of the schematic illustrated pane 8 of a microwave window 1 according to the invention is illustrated in FIG. 2a. The pane 8 is set in a metallic mounting bracket 13 in this embodiment. The size relations and the number of indentations or recesses 9 are shown only as an example in order to illustrate the basic construction. The pane 8 has three recesses 9 or thinned areas on a side 6 that are shown in the form of angular recesses here. The depth of the recesses 9 defines the height of the sections of the pane 2 around which the indentation-free layer extends and which acts overall as adaptation layer. In order to reduce reflection, the depth of the recesses 9 should equal an uneven multiple of one fourth of the wavelength of the measuring signal. Furthermore, the thickness of the indentation-free layer is equal to an integral multiple of half the wavelength. Both thicknesses reduce, individually or together, reflection on the pane 8. In the designs of FIGS. 2b & 2c, indentations are also found on the other side 7, the recesses 9 on both sides being aligned in FIG. 2b and offset in FIG. 2c.

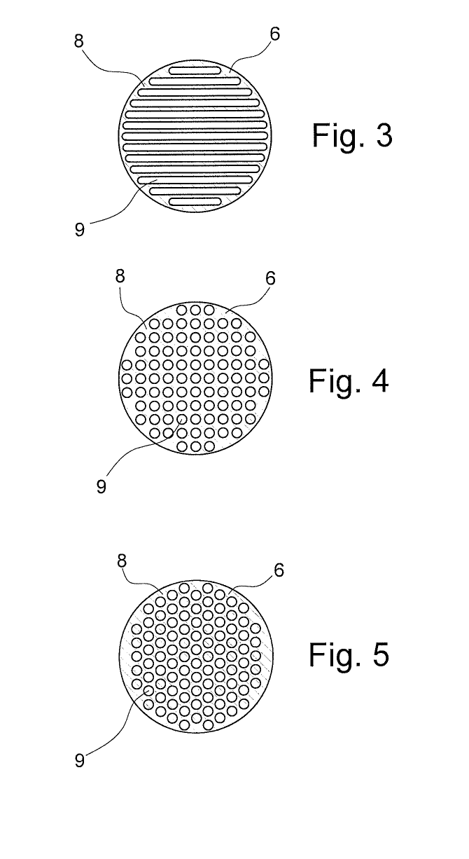

FIGS. 3 to 5 show three different variations of the design of the recesses 9 and their arrangement on one side of the pane 8, but arrangement on both sides is possible similar to the cases of FIGS. 2b & 2c. Here, the pane 8 is circular in each of the illustrated variations, but a circular shape is not required. Furthermore, the surface area of the recesses 9 is greater than the area of the surface of the side 6 that is indentation-free. In the variation in FIG. 3, the indentations are designed as elongate slots that are arranged parallel to one another. The grid structure results in a dependency of the interaction between the polarization of the microwaves used for measurement and the pane 8. In the variations in FIGS. 4 & 5, the indentations 9 are cylinders having essentially circular base areas, but the bases can have other shapes. The longitudinal axes of the cylinders run, in particular, perpendicular to the surface of the side 6, in which the indentations 9 are found. The cylindrical recesses 9 of the variations in FIGS. 4 & 5 are each arranged on points of a coordinate system spanning uniform increments, Cartesian, on the one hand (FIG. 4) and hexagonal (FIG. 5), on the other hand. In this manner, the dependency on orientation required in the variation according to FIG. 3 is omitted.

What is claimed is:

1. Microwave window for spatial separation and microwave connection of a first space with a second space comprising an at least partially microwave-transparent pane with two opposite sides, wherein the pane has at least one indentation or recess on at least one side.

2. Microwave window according to claim 1, wherein said at least one indentation or recess comprises multiple indentations or recesses.

3. Microwave window according to claim 2, wherein an area on the side with indentations or recesses is different from an area on the same said without indentations or recesses.

4. Microwave window according to claim 1, wherein the at least one indentation or recess has dimensions in at least one direction a plane of the microwave window that are smaller than the wavelength of electromagnetic radiation to be transmitted through the microwave window.

5. Microwave window according to claim 2, wherein at least a part of the indentations or recesses are slot-shaped and wherein at least some of the slot-shaped indentations or recesses are arranged essentially parallel to one another.

6. Microwave window according to claim 2, wherein at least some of the indentations or recesses are essentially cylindrical and wherein at least some of the cylindrical indentations or recesses are arranged on the side of the window as points on an essentially Cartesian coordinate system.

7. Microwave window according to claim 2, wherein at least some of the indentations or recesses are essentially cylindrical and wherein at least some of the cylindrical indentations or recesses are arranged on the side of the window as points on an essentially hexagonal coordinate system.

8. Microwave window according to claim 1, wherein the pane has at least one indentation or recess on each of the opposite sides of the window.

9. Fill level sensor that is operable on the radar principle, comprising:
at least one antenna emitting electromagnetic radiation and
at least one microwave window for spatial separation and microwave connection of a first space with a second space comprising an at least partially microwave-transparent pane with two opposite sides, wherein the pane has at least one indentation or recess on at least one side.

10. Fill level sensor according to claim 9, wherein the depth of the at least one indentation or recess is essentially equal to one fourth of the wavelength of the electromagnetic radiation guided through the pane.

11. Fill level sensor according to claim 9, wherein said at least one indentation or recess comprises multiple indentations or recesses.

12. Fill level sensor according to claim 9, wherein at least a part of the indentations or recesses are slot-shaped and wherein at least some of the slot-shaped indentations or recesses are arranged essentially parallel to one another.

13. Fill level sensor according to claim 9, wherein at least some of the indentations or recesses are essentially cylindrical and wherein at least some of the cylindrical indentations or recesses are arranged on the side of the window as points on an essentially Cartesian coordinate system.

14. Fill level sensor according to claim 9, wherein at least some of the indentations or recesses are essentially cylindrical and wherein at least some of the cylindrical indentations or recesses are arranged on the side of the window as points on an essentially hexagonal coordinate system.

15. Fill level sensor according to claim 9, wherein said window is mounted in a wall of a container, wherein said first space is the ambient space in which the container is located and wherein the second space is within the container, between the window and a material the level of which is to be measured.
